(19) United States
(12) Patent Application Publication
(10) Pub. No.: US 2010/0089563 A1
(43) Pub. Date: Apr. 15, 2010

(54) VEHICLE AIR CONDITIONING IMPROVEMENT

(76) Inventors: Shaam P. Sundhar, Princeton, NJ (US); Heng Soon Lee, Selangor (MY); Rahul Sankhla, Bangalore (IN)

Correspondence Address: QUICKPATENTS, INC., 32861 CALLE PERFECTO, SUITE A, SAN JUAN CAPISTRANO, CA, 92675, US

(21) Appl. No.: 12/471,117

(22) Filed: May 22, 2009

Related U.S. Application Data
(60) Provisional application No. 61/196,121, filed on Oct. 15, 2008.

(51) Int. Cl. B60H 1/00

(52) U.S. Cl. 165/202; 165/61

(57) ABSTRACT

The present device is a temperature regulation system for a vehicle turned on or off. The temperature regulation system includes a rechargeable battery for supplying power to an air moving system and a heat exchanger in accordance with demand signals from the thermostat, independent of the on/off state of the ignition system. In one embodiment, a DC motor is electrically connected to the rechargeable battery and rotationally coupled to a variable-speed compressor replacing the existing compressor of the vehicle, improving efficiency and extending the use of the rechargeable battery. The temperature regulation system may be used to heat or to cool the vehicle when the temperature of the air in the vehicle exceeds a certain threshold.

### CROSS-REFERENCE TO RELATED APPLICATIONS

This application claims the benefit of U.S. Provisional Patent Application 61/196,121, filed on Oct. 15, 2008, and incorporated herein by reference.

### STATEMENT REGARDING FEDERALLY SPONSORED RESEARCH AND DEVELOPMENT

Not Applicable.

### FIELD OF THE INVENTION

This invention relates to environmental heating and cooling systems, and more particularly to an improved such system for a vehicle.

### DISCUSSION OF RELATED ART

One of the most unpleasant experiences an automobilist has to endure is to return to his vehicle parked outside on a hot sunny day, and find the temperature inside quite unbearable and suffocating. The same is the case in winter, in which case the temperature dips to the other extreme once the heater is switched off, and vehicle locked.

Some of the methods employed at present to solve the abovementioned issues are to roll down the windows slightly, and using window shields or blinds to decrease exposure of the vehicle to direct sunlight. Currently these methods are used to decrease the interior temperature to some extent but not to a comfortable level, not even to the outside ambient temperature when the weather is hot.

However, the aforementioned attempts are cumbersome to use and inefficient. Attempts like blocking the rays of the sun merely reduce the temperature of the heated air, as opposed to eliminating the heated air from the cabin of the vehicles. Also, the air conditioner can only function if the vehicle's ignition system is in operation. Attempts to keep the temperature inside parked vehicles by insulating the vehicle or using thermoelectric modules is a tested method, but the thermoelectric heating/cooling modules required for such a design are expensive and generally require huge amounts of power for its operation. Therefore, there is a need for a device that can be operated when the ignition system is on or off. Also, there is a need for a temperature regulation system to maintain the temperature of the interior of the vehicle close to ambient so that people entering their vehicle will not experience a furnace-like hot temperature. If the ambient and the interior temperatures are similar, people will not experience any difference. When the ignition is started, the air conditioner need not fight the build up of heat, so the cooler temperature is achieved in a shorter time. Further, in the conventional vehicle, a study of the optimal usage of air conditioner reveals that a high capacity cooling power is needed only for the first few minutes after the person driving the car enters the vehicle. This is to get rid of the excessive built-up heat in the vehicle and let the interior cool down quickly. Once the temperature inside the cabin drops to a desired comfortable level, less power is needed to maintain it. On the other hand, if the weather is too cold, a separate heating system would be required to warm the passenger cabin of the vehicle. Having a separate heating system and cooling system would be inefficient and more expensive. Thus, there is a need for a temperature regulation system that can maintain a desired temperature range in the vehicle. Also, there is a need for a single system that can maintain a desired temperature range in both hot weather and cold weather conditions.

In the prior art literature, U.S. Pat. No. 4,955,203 issued to Sundhar on Sep. 11, 1990, titled “Air conditioner for parked automotive vehicle,” discloses an air conditioning unit. This device discloses for a parked automotive vehicle having a cooling unit comprising a cooling chamber with at least one insulated wall having on opposite sides thereof a heat sink and a cooling block having there between a thermoelectric chip. However, as per the '203 invention, it would require creation of a separate duct system to carry the cold air from trunk to inside the car. Also, in order to implement this design, it is required to drill holes at the metal floor of the trunk for air intake and outflow. Therefore, there is a need for a device that provides the advantage of using the vehicles existing duct system.

Another U.S. Pat. No. 6,453,678 issued to Sundhar on Sep. 24, 2002, titled “Direct current mini air conditioning system,” discloses an air conditioning unit which is provided for a parked truck/boat to cool the sleeping cabin. However, the mechanism is not efficient in its operation. Therefore, there is a strong need for a device that operates more efficiently to extend battery usage.

From the foregoing, it becomes apparent that there is a need for a system that optimally conditions the air inside the cabin of a parked vehicle, and also during the times when the vehicle is being driven, such that the temperature in the vehicle compartment remains within a desired range. The present invention attempts to bridge the shortcomings in the state of the art literature by proposing an air-conditioning system for vehicles.

Therefore, there is a need for a temperature regulation system that can be operated when the ignition system is on or off. The needed temperature regulation system would maintain comfortable desired temperatures in the vehicle. Further, there is a need for a single system that can maintain comfortable temperatures in both hot weather and cold weather conditions. Also, the needed device would provide the advantage of using the vehicles existing duct and ventilation system. Finally, such a need system would operate more efficiently to extend battery usage. The present invention accomplishes these objectives.

### SUMMARY OF THE INVENTION

The present device is a temperature regulation system for a vehicle having an ignition system and an air moving system. The air moving system circulates air inside of the vehicle across a heat exchanger to maintain a desired temperature range within the vehicle with a thermostat. The temperature regulation system includes a rechargeable battery for supplying power to the air moving system and the heat exchanger in accordance with demand signals from the thermostat and independent from an on/off state of the ignition system.

The temperature regulation system further includes a brushless DC motor for driving a variable-speed compressor. The DC motor is electrically connected to the rechargeable battery and rotationally coupled to the variable-speed compressor which is connected to the heat exchanger. The variable-speed compressor acts in place of the existing compressor of the vehicle.

The rechargeable battery may be at least one lithium ion battery or, as desired, may be at least one lithium-phosphate battery. The rechargeable battery is adapted to electrically power the ignition system of the vehicle when the thermostat detects the temperature of the air inside the vehicle has exceeded the desired temperature range. The heat exchanger may be used to heat the air when the temperature of the air in the vehicle drops below a set lower threshold or to cool the air when the temperature of the air in the vehicle rises above a set upper threshold.

In another embodiment, the system further includes at least one heat-reflecting window shield, which has a heat-reflecting coating for example, for reflecting heat away from the at least one window.

The present invention is a temperature regulation system that can be operated when the ignition system is on or off. Further, the invention is a system that can maintain desired temperature ranges in both hot weather and cold weather conditions. Also, the device provides the advantage of using the vehicles existing duct and ventilation system. In addition in hot weather, the fan of the air conditioning can be operated continuously when parked to lower interior temperature, using less power than the air conditioning system. Finally, the invention operates more efficiently to extend battery usage. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a functional block diagram of a temperature regulation system;

FIG. 2 is a functional block diagram of a thermostat;

FIG. 3 is a functional diagram showing how components of the invention are connected; and

FIG. 4 is a is functional block diagram of another embodiment of the invention, illustrating a DC motor connected to an existing compressor via a belt.

### DETAILED DESCRIPTION OF THE PREFERRED EMBODIMENT

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

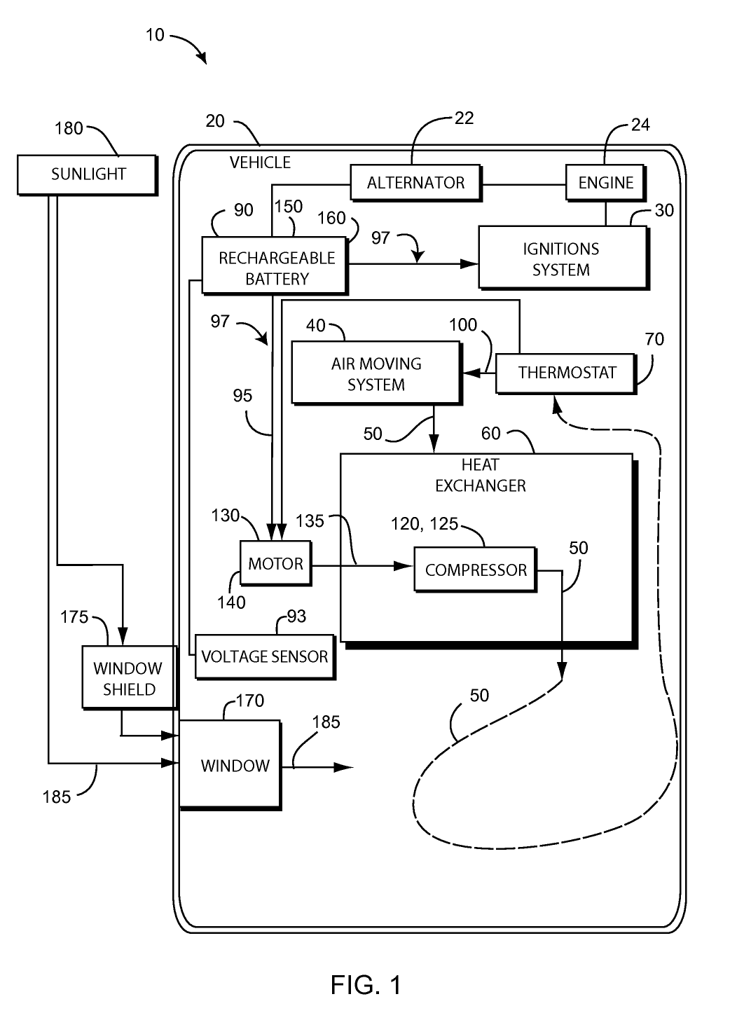

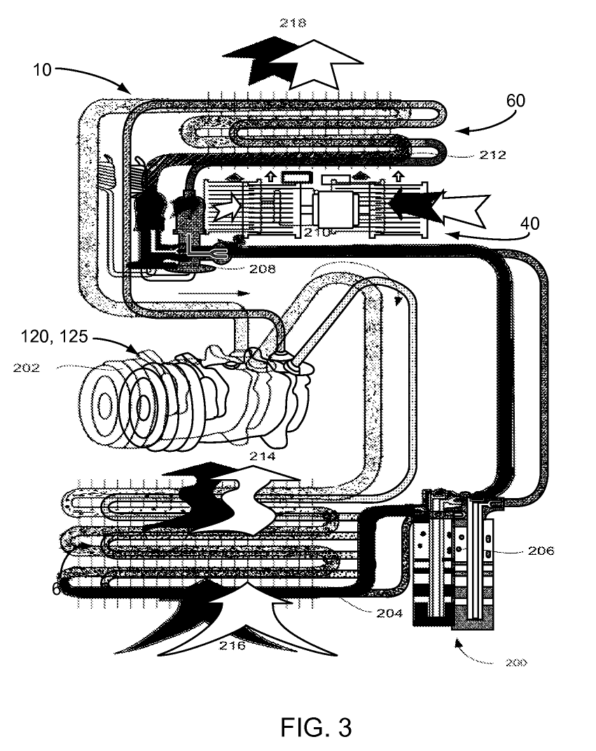

With respect to the drawings, FIGS. 1 and 3 illustrate a temperature regulation system 10 for a vehicle 20 having an ignition system 30 and an air moving system 40. The air moving system 40 circulates air 50 inside of the vehicle 20 across a heat exchanger 60 to maintain a desired temperature range 72 within the vehicle 20 with a thermostat 70. The temperature regulation system 10 includes a rechargeable battery 90 for supplying power 95 to the air moving system 40 and the heat exchanger 60 in accordance with demand signals 100 from the thermostat 70 and independent from an on/off state of the ignition system 30.

In one embodiment, the heat exchanger 60 of the vehicle 20 includes a compressor 120. The temperature regulation system 10 further includes a motor 130 for driving the compressor 120. The motor 130 is electrically connected 97 to the rechargeable battery 90 and rotationally coupled 135 to the compressor 120. In a preferred embodiment, the motor 130 is a brushless DC motor 140. Preferably, the DC motor 140 operating voltage ranges from 12 VDC to 300 VDC

In another embodiment, the temperature regulation system 10 further includes a variable-speed compressor 125. In this embodiment, the variable-speed compressor 125 acts in place of the existing compressor 120 of the vehicle 20. In a preferred embodiment, the DC motor 140 is rotationally coupled 135 to the variable-speed compressor 125 which is connected to the heat exchanger 60. The variable-speed compressor 125 can be made by deploying a rotary pump or a piston pump or a scroll pump (not shown).

In one embodiment, the rechargeable battery 90 may be at least one lithium ion battery 150. In another embodiment, the rechargeable battery 90 may be at least one lithium-phosphate battery 160. The temperature regulation system 10 may also include a bank (not shown) of rechargeable batteries 90. The rechargeable battery 90 is adapted to electrically power the ignition system 30 of the vehicle 20 when the thermostat 70 detects the temperature of the air 40 inside the vehicle 20 has exceeded the desired temperature range 72. The rechargeable battery 90 may be placed under the hood or under the front passenger seat (not shown) or other suitable locations in the vehicle 20. The motor 130 is preferably located under the hood (not shown) of the vehicle 20. In one embodiment, the rechargeable battery 90 is adapted to electrically power the temperature regulation system 10 when the thermostat 70 detects the temperature of the air 40 inside the vehicle 20 has exceeded the desired temperature range 72, the temperature regulation system 10 being able to power the air moving system 40 of the vehicle independent of the vehicle's on/off state.

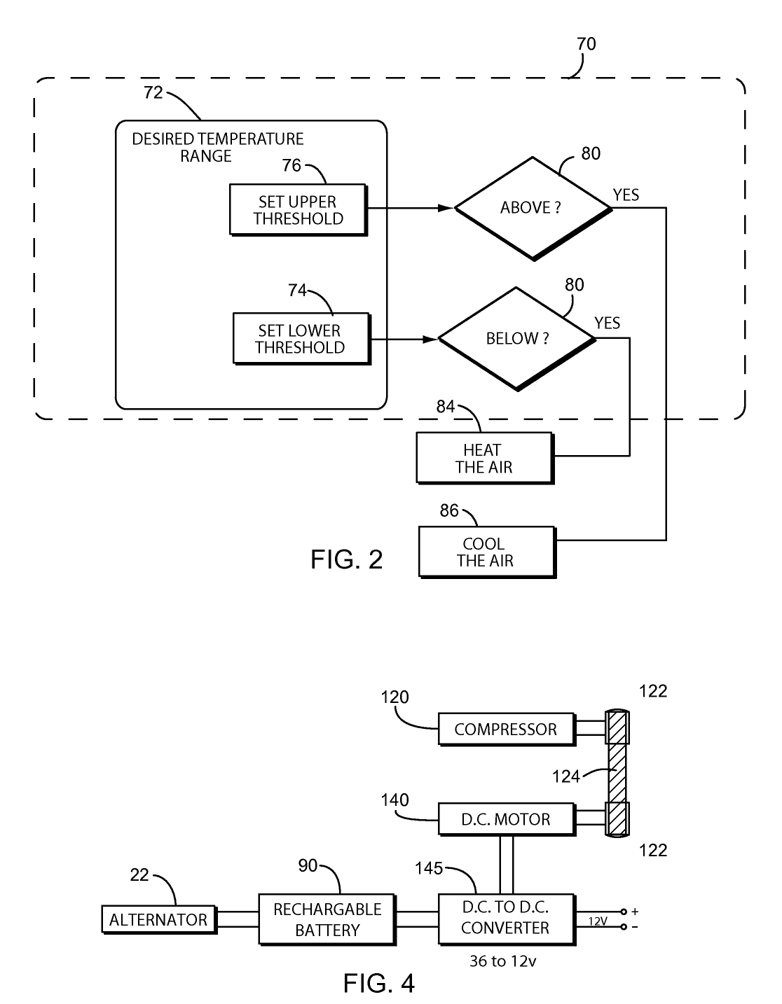

In one embodiment, as illustrated in FIG. 2, the heat exchanger 60 may be used to heat 84 the air 40 when the temperature of the air 40 in the vehicle 20 drops below a set lower threshold 74, or to cool 86 the air 40 when the temperature of the air 40 in the vehicle 20 rises above a set upper threshold 76.

In another embodiment, the vehicle 20 includes at least one window 170, the system 10 further including at least one heat-reflecting window shield 175 for reflecting heat 185 away from the at least one window 170. The shield 175 is preferably easy to deploy and retrieve.

In another embodiment, the rechargeable battery 90 is preferably a Lithium-Ion battery 150 of about 3.0 KWH. If temperature regulation system 10 is installed in a hybrid vehicle (not shown) then the rechargeable battery 90 storage capacity should be increased up to 3 KWH. In a pure electric vehicle (not shown) there will be no onboard engine 24 to charge the rechargeable battery 90. Therefore, the storage capacity of the rechargeable battery 90 of an electric vehicle will be much higher than a hybrid vehicle, typically 16 KWH, and the storage capacity is enough for the functioning of the temperature regulation system 10.

When the vehicle 20 is parked, the input power to the temperature regulation system 10 comes from the high capacity rechargeable battery 90, wherein preferably up to 80% of its stored energy is sufficient to power the temperature regulation system 10 for at least 8 hours. When the vehicle 20 is in motion, an alternator 22 connected to an engine 24 of the vehicle 20 charges the rechargeable battery 90 in addition to supplying electrical power to run temperature regulation system 10. In one embodiment, the rechargeable battery 90 is recharged using a high power-high voltage alternator 22. The alternator 22 may be selected with an output voltage that matches the DC motor 140 used in the temperature regulation system 10. It can be noted that a D.C. to D.C. step down solid state transformer 145 may be used if 12 Volts D.C. is required.

When the vehicle 20 is parked under the hot sun, the D.C. temperature regulation system 10 operates intermittently (not the engine 24 of the vehicle 20) to cool down the temperature inside the vehicle 20. A thermostat 70 located in the interior of the vehicle 20 will sense the rise in temperature. When the temperature of the air 50 inside the vehicle 20 goes outside of the desired temperature range 72, then the temperature regulation system 10 turns on the variable-speed compressor 125. The stored energy in the rechargeable battery 90 energizes the temperature regulation system 10. The existing air moving system 40 in the vehicle 20 is also turned on and powered by the rechargeable battery 90. The air moving system 40 operates at much less power than the variable-speed compressor 125 and has a smaller effect on the temperature regulation system's 10 overall performance.

In order to minimize the current drain of the rechargeable battery 90, the variable-speed compressor 125 may be operated intermittently at low speed. That is, the variable-speed compressor's 125 volumetric displacement can be made variable, thereby decreasing the energy used. Thus, the rechargeable battery 90 may be used more economically. Also, it is to be noted that the operation of the temperature regulation system 10 is reversible. That is, the temperature regulation system 10 can be made to either heat or cool the air 50 in the vehicle 20.

Even though the BTU/Hour cooling power of the variable-speed compressor 125 is smaller compared to a conventional mechanical driven system (not shown), the total displacement rate can be increased by increasing the speed of the variable-speed compressor 125. Another advantage with small volumetric displacement is that the starting torque is lower as the torque is dependent on the variable-speed compressor's 125 pressure and surface area. So the smaller the surface area of the variable-speed compressor 125, the smaller will be the force, and hence the required torque. A highly efficient variable-speed compressor 125 will keep the vehicle 20 temperature within the desired range. Thus, there is no need to idle the vehicle engine 24 to maintain the desired temperature range 72 and when the engine 24 is running the alternator 22 charges the rechargeable battery 90. In another embodiment, the vehicle 20 is made to “breathe” by operating the air moving system 40 continuously when parked, and when the vehicle's ignition system 30 and/or engine 24 are in an off state, which can reduce about 25% of the built-up heat depending upon air flow.

To preserve the rechargeable battery power when the engine 24 is off, the thermostat 70 controls turning on and off the temperature regulation system 10. Preferably in one embodiment for hot weather, the air moving system 40 of the vehicle 20 is running all the time while the vehicle 20 is parked and the engine 24 is off. In hot weather, running the air moving system 40 continuously, drawing in ambient air from outside of the vehicle 20, lowers the interior temperature and consumes less power than continuously operating the entire temperature regulation system 10.

In hot weather, when the vehicle 20 is unoccupied, the thermostat 70 is preferably set to a temperature equal or very close to the outside ambient temperature. In this way, people entering the vehicle 20 will not feel a strong difference in temperature from outside of the vehicle 20 and inside the vehicle 20. In hot weather, by maintaining ambient temperature when the vehicle 20 is unoccupied, the temperature regulation system 10 preserves the rechargeable battery 90. In another preferred embodiment, a voltage sensor 93 will keep sensing the voltage of the rechargeable battery 90. When the voltage reaches approximately just above 12 volts, the voltage sensor 93 will shut off the temperature regulation system 10. In this way, the rechargeable battery 90 will have enough power to start the vehicle 20.

In a preferred embodiment, the temperature regulation system 10 has a high COP of 3.00 which means that for every unit of power input to the variable-speed compressor 125 will result in moving 3 units. The input electrical power needed to move 1,148.4 Watts of heat will be equal to 382.8 Watts (1,148.4/3). For continuous 8 hours of operation, the required energy would be 382.8 watts multiplied into 8 hours, which adds up to 3,063 Watt hours or 3.063 kWh. A high energy density rechargeable lithium ion battery is preferably used which will have a 90 AH at 42 Volts (slightly less than 4 kWH).

FIG. 4 illustrates another embodiment of the temperature regulation system 10 wherein the brushless DC motor 140 for driving the compressor 120 is variable speed and the brushless DC motor 140 is electrically connected to the rechargeable battery 90 and mechanically coupled to the existing compressor 120 by pulleys 122 and a belt 124. This embodiment provides the advantage and convenience of using the vehicle's existing compressor 120.

While a particular form of the invention has been illustrated and described, it will be apparent that various modifications can be made without departing from the spirit and scope of the invention. For example, though in a preferred embodiment, only one rechargeable battery 90 is used, additional rechargeable batteries 90 may be added to the vehicle 20 if desired. Accordingly, it is not intended that the invention be limited, except as by the appended claims.

The teachings provided herein can be applied to other systems, not necessarily the system described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description details certain embodiments of the invention and describes the best mode contemplated, no matter how detailed the above appears in text, the invention can be practiced in many ways. Details of the system may vary considerably in its implementation details, while still being encompassed by the invention disclosed herein.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventor contemplates the various aspects of the invention in any number of claim forms.

Accordingly, the inventor reserves the right to add additional claims after filing the application to pursue such additional claim forms for other aspects of the invention.

What is claimed is:

1. A temperature regulation system for a vehicle having an ignition system and an air moving system that circulates air inside of the vehicle across a heat exchanger to maintain a desired temperature range within the vehicle with a thermostat, the system comprising:
a rechargeable battery for supplying power to the air moving system and the heat exchanger in accordance with demand signals from the thermostat and independent from an on/off state of the ignition system.

2. The temperature regulation system of claim 1 wherein the heat exchanger of the vehicle includes a compressor, and wherein the temperature regulation system further includes a motor for driving the compressor, the motor electrically connected to the rechargeable battery and rotationally coupled to the compressor.

3. The temperature regulation system of claim 2 wherein the motor is a brushless DC motor.

4. The temperature regulation system of claim 3 wherein the rechargeable battery is at least one lithium ion battery.

5. The temperature regulation system of claim 3 wherein the rechargeable battery is at least one lithium-phosphate battery.

6. The temperature regulation system of claim 1 wherein the rechargeable battery is adapted to electrically power the ignition system of the vehicle when the thermostat detects the temperature of the air inside the vehicle has exceeded the desired temperature range.

7. The temperature regulation system of claim 1 wherein the heat exchanger may be used to heat the air when the temperature of the air in the vehicle drops below a set lower threshold, or to cool the air when the temperature of the air in the vehicle rises above a set upper threshold.

8. The temperature regulation system of claim 2 further including a variable-speed compressor.

9. The temperature regulation system of claim 1 wherein the vehicle includes at least one window, the system further including at least one heat-reflecting window shield for reflecting heat away from the at least one window.

10. The temperature regulation system of claim 1 further including a high power-high voltage alternator to charge the rechargeable battery.

11. The temperature regulation system of claim 1 wherein the air moving system wherein the rechargeable battery supplies power to the air moving system when the ignition system is in the off state, whereby air is circulated inside the vehicle continuously when the ignition system is in the off state.

12. A temperature regulation system for a vehicle having an ignition system and an air moving system that circulates air inside of the vehicle across a heat exchanger, having a compressor, to maintain a desired temperature range within the vehicle with a thermostat, the system comprising:
a rechargeable battery for supplying power to the air moving system and the heat exchanger in accordance with demand signals from the thermostat and independent from an on/off state of the ignition system;
a variable speed brushless DC motor for driving the compressor, the motor electrically connected to the rechargeable battery and mechanically coupled to the compressor by pulleys and a belt.

13. The temperature regulation system of claim 12 further including a high power-high voltage alternator to charge a rechargeable battery.

14. The temperature regulation system of claim 12 wherein the rechargeable battery is at least one lithium ion battery.

15. The temperature regulation system of claim 12 wherein the rechargeable battery is at least one lithium-phosphate battery.

16. The temperature regulation system of claim 12 further including a heat reflecting window shield to lower the heat of the interior when the vehicle is turned off.

17. The temperature regulation system of claim 12 wherein the air moving system continuously operates when the vehicle is turned off to lower the interior temperature.

18. The temperature regulation system of claim 12 wherein the air moving system wherein the rechargeable battery supplies power to the air moving system when the ignition system is in the off state, whereby air is circulated inside the vehicle continuously when the ignition system is in the off state.

19. The temperature regulation system of claim 1 wherein the rechargeable battery is adapted to electrically power the temperature regulation system when the thermostat detects the temperature of the air inside the vehicle has exceeded the desired temperature range.

20. The temperature regulation system of claim 12 wherein the rechargeable battery is adapted to electrically power the temperature regulation system when the thermostat detects the temperature of the air inside the vehicle has exceeded the desired temperature range.
